(19) United States
(12) Patent Application Publication
(10) Pub. No.: US 2014/0370971 A1
(43) Pub. Date: Dec. 18, 2014

(54) USING PERSONAL DEVICES TO CONNECT NETWORK-LIMITED WAGERING GAME MACHINES

(71) Applicant: WMS Gaming, Inc., Waukegan, IL (US)

(72) Inventors: Sean P. Kelly, Chicago, IL (US); Joel R. Jaffe, Glenview, IL (US); Justin A. Perkins, Chicago, IL (US); Nickey C. Shin, Chicago, IL (US); Craig J. Sylla, Round Lake, IL (US)

(21) Appl. No.: 14/303,416

(22) Filed: Jun. 12, 2014

Related U.S. Application Data
(60) Provisional application No. 61/834,043, filed on Jun. 12, 2013.

(51) Int. Cl. G07F 17/32

(52) U.S. Cl. CPC G07F 17/3225
USPC 463/25

(57) ABSTRACT

Communications capability between two wagering game machines is provided using personal devices of users of the wagering game machines. At least one of the wagering game machines is a network-limited wagering game machine that is not communicably coupled to a casino operator's network. A first user communicably couples a personal device such as a mobile phone to a wagering game machine and a second user communicably couples a personal device to a wagering game machine. The two wagering game machines communicate using a communication path formed by the two personal devices and a network such as a mobile phone network communicably coupling the two personal devices.

### RELATED APPLICATIONS

This application claims the priority benefit of U.S. Provisional Application Ser. No. 61/834,043 filed Jun. 12, 2013.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2014, WMS Gaming, Inc.

### FIELD

Embodiments of the inventive subject matter relate generally to wagering game systems, and more particularly to wagering game systems utilizing personal devices to form network connections between wagering game machines.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments are illustrated in the Figures of the accompanying drawings in which:

FIG. 1 is a block diagram illustrating components of a system for using personal devices to connect network-limited wagering game machines according to embodiments.

FIG. 2 is a block diagram illustrating components of a system for using personal devices to connect network-limited wagering game machines according to alternative embodiments.

FIG. 3 is a flowchart illustrating a method for communicably coupling wagering game machines using personal devices.

FIG. 4 is a flowchart illustrating a method for a multiplayer game on wagering game machine communicably coupled using personal devices.

FIG. 5 is a block diagram illustrating a wagering game machine architecture, according to example embodiments.

FIG. 6 is a perspective view of a wagering game machine, according to example embodiments.

### DESCRIPTION OF THE EMBODIMENTS

This description of the embodiments is divided into five sections. The first section provides an introduction to embodiments, while the second section describes example wagering game machine architectures. The third section describes example operations performed by some embodiments and the fourth section describes example wagering game machines in more detail. The fifth section presents some general comments.

### Introduction

This section provides an introduction to some embodiments of the disclosure. Generally speaking, the embodiments provide communications capability between two wagering game machines using personal devices of users of the wagering game machines. At least one of the wagering game machines is a network-limited wagering game machine. As used herein, the term network-limited wagering game machine is used to refer to a wagering game machine for which alternative network connectivity, if present at all, is insufficient for the transaction of one or more game features e.g. due to bandwidth limitations, differences in communication protocol, security concerns, or the selection of remote machines accessible over the network. For example, a wagering game machine connected to an accounting server via a slot accounting network may still be considered network-limited by a game which requires an IP (Internet Protocol) connection to an adjacent wagering game machine for a bonus event. In some embodiments, a first user communicably couples a personal device such as a mobile phone to a wagering game machine and a second user communicably couples a personal device to another wagering game machine. The two wagering game machines may then communicate using a communication path formed by the two personal devices and a network such as a mobile phone network communicably coupling the two personal devices.

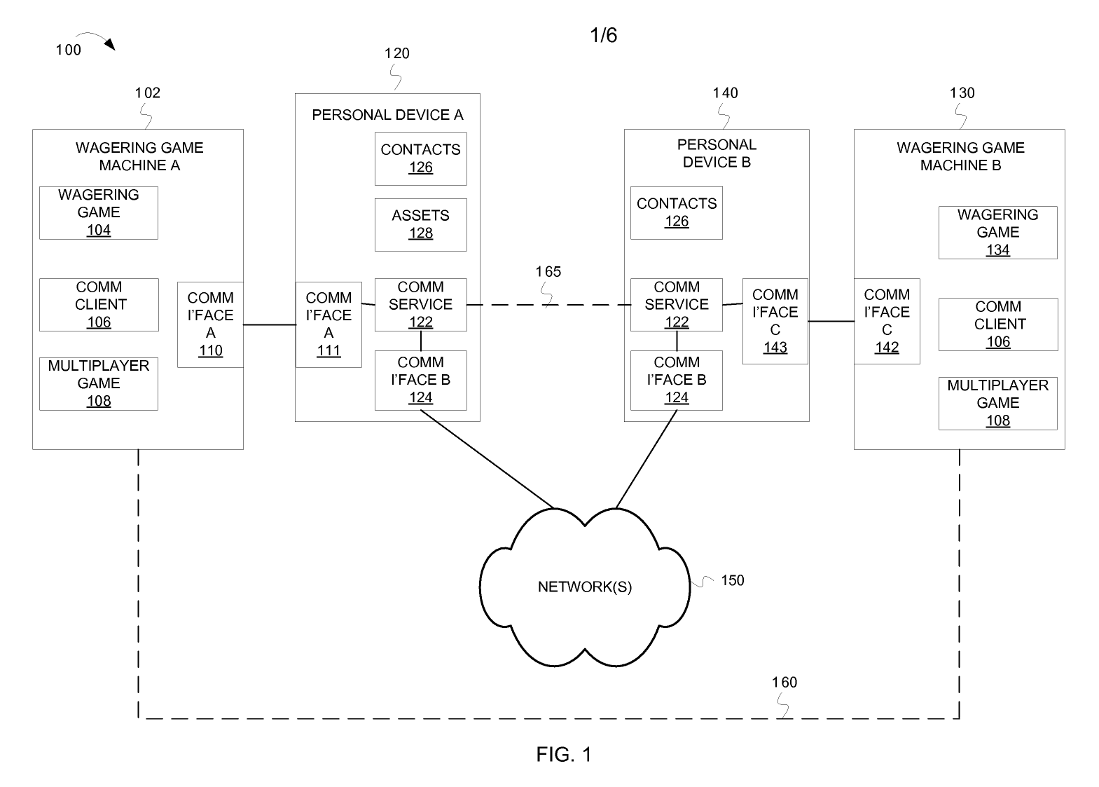

FIG. 1 is a block diagram illustrating components of a system 100 for using personal devices to connect wagering game machines according to embodiments. In some embodiments, system 100 includes a first wagering game machine 102, a first personal device 120, a second wagering game machine 130, a second personal device 140 and a network 150 capable of communicably coupling personal device 120 and personal device 140. Either or both of first wagering game machine 102 and second wagering game machine 130 may be network-limited wagering game machines. The network-limited wagering game machines may be network-limited based on a software configuration or hardware configuration.

Wagering game machine 102 can be an electromechanical wagering game machine configured to play wagering games 104. Wagering game 104 presented on wagering game machine 102 can be a mechanical slots game. Alternatively, wagering game 104 can be an electronic wagering game including video casino games, such as blackjack, slots, keno, poker, blackjack, roulette, etc. The embodiments are not limited to any particular wagering game 104.

Wagering game machine 102 also includes a communication interface 110 and communications client 106. Communication interface 110 may be any type of communication interface suitable for communicably coupling wagering game machine 102 to a personal device 120. In some embodiments, communication interface 102 may be a WLAN interface, a BLUETOOTH® (Bluetooth) interface, a WiMAX interface, a ZigBee® interface, a Wireless USB interface, an NFC (Near Field Communications) interface etc. In alternative embodiments, a personal device 120 may be docked to wagering game machine 102. For example, wagering game machine 102 may be coupled to personal device 120 via a USB cable.

Communications client 106 makes use of communication interface 110 and may implement a discovery protocol to either determine whether there are any personal devices available for communications or to advertise the availability of wagering game machine 102 for communications with a personal device.

Personal device 120 may be any handheld or portable computing device carried by a user. Examples of such personal devices includes mobile phones (e.g., smart phones), tablet computers, laptop computers etc. Personal device 120 includes a communication interface 111 and a communications service 122. Communication interface 111 is an interface compatible with the communication interface 110 of wagering game machine 102. That is, communication interface 111, like communication interface 110, may be a wireless communication interface such as a WLAN interface, a BLUETOOTH® (Bluetooth) interface, a WiMAX interface, a ZigBee® interface, a Wireless USB interface, an NFC (Near Field Communications) interface etc. Alternatively, communication interface 111 may be a wired interface such as a USB interface.

Personal device 120 also includes a second communication interface 124. Communication interface 124 may be an interface suitable for wide area communications. For example, in some embodiments, communication interface 124 is a 4G LTE (Long Term Evolution) interface. In alternative embodiments, communication interface 124 may be a 3G or other mobile device communication interface. In further alternative embodiments, communication interface 124 may be a wireless network interface.

In some embodiments, communications service 122 implements a discovery protocol provide the capability for personal device 120 to discover nearby (e.g., within communications range) wagering game machines. Alternatively, communications service 122 may advertise the presence of the personal device 120 for connection with a wagering game machine 102. In addition, communications service 122 routes data and commands received from communication interface 111 to communication interface 124 and vice versa. Further, communication service 122 may translate data and commands into a format that is compatible with either communication interface 111 or communication interface 124. Thus personal device 120 can be configured as a gateway between wagering game machine 102 and other devices on network 150. Communications service 122 may be configured as an application that is started by a user of personal device 120, or it may be a service that is automatically started when personal device 120 is powered on.

A second wagering game machine, wagering game machine 130, may be configured similarly to wagering game machine 102. For example, wagering game machine 130 may be configured to play one or more wagering games 134. Like wagering game 104, wagering game 134 may be a mechanical slots game. Alternatively, wagering game 134 can be an electronic wagering game including video casino games, such as blackjack, slots, keno, poker, blackjack, roulette, etc. The embodiments are not limited to any particular wagering game 134. Wagering game 134 may be the same game as wagering game 104, or it may be a different wagering game.

Wagering game machine 130 also includes a communication interface 142 and communications client 106. Communication interface 142 may be any type of communication interface suitable for communicably coupling wagering game machine 130 to a personal device 140. In some embodiments, communication interface 142 may be a WLAN interface, a BLUETOOTH® (Bluetooth) interface, a WiMAX interface, a ZigBee® interface, a Wireless USB interface, an NFC (Near Field Communications) interface etc. In alternative embodiments, a personal device 140 may be docked to wagering game machine 130. For example, wagering game machine 132 may be coupled to personal device 140 via a USB cable. Although communication interface 142 may be the same type of interface as communication interface 110, it may be a different interface. For example, communication interface 110 on wagering game machine 102 may be a Bluetooth interface while communication interface 142 on wagering game machine 130 may be a WiFi interface.

Communications client 106 makes use of communication interface 142 and may implement a discovery protocol to either determine whether there are any personal devices available for communications or to advertise the availability of wagering game machine 130 for communications with a personal device.

Personal device 140 may be any handheld or portable device carried by a user and may be configured similarly to personal device 120. Like personal device 120, personal device 140 may be a mobile phone (e.g., a smart phone), a tablet computer, a laptop computer etc. Personal device 140 may be the same type of device as personal device 120 or it may be a different type of device. For example, personal device 120 may be a smart phone and personal device 140 may be a tablet computer.

Personal device 140 includes a communication interface 143 and a communications service 122. Communication interface 143 is an interface compatible with the communication interface 142 of wagering game machine 130. That is, communication interface 143, like communication interface 142, may be a wireless communication interface such as a WLAN interface, a BLUETOOTH® (Bluetooth) interface, a WiMAX interface, a ZigBee® interface, a Wireless USB interface, an NFC (Near Field Communications) interface etc. Alternatively, communication interface 111 may be a wired interface such as a USB interface.

Personal device 140 also includes a second communication interface 124 for coupling personal device 140 to network 150. As noted above, communication interface 124 may be an interface suitable for wide area communications such as a 4G LTE, 3G or wireless network interface.

Personal device 140 also includes communications service 122 as described above with respect to personal device 120. Communications service 122 provides gateway functions to wagering game machine 130 such that wagering game machine 130 may communicate on network 150 through personal device 140.

Either or both of personal device 120 and personal device 140 may include contact data 126. Such contact data may include user identifiers, email addresses, phone numbers and other data regarding contacts of a user of personal device 120 or personal device 140. Although shown as one entity on FIG. 1, contact data 126 may be spread across multiple data bases or data files. For example, contact data 126 may be an email contact database and a separate social network contact database such as that maintained by Player's Life provided by WMS Gaming Inc., Facebook, Twitter, Google+ etc. Contact data 126 may be used to send a request from a user at a first personal device (e.g., personal device 120) to a user at a second personal device (e.g., personal device 140) asking the user of the second personal device to connect their personal device to a wagering game machine and to initiate a communication session 165 between the communication services 122 on personal device 120 and personal device 140. Upon establishment of a communication session, data and commands may be sent between wagering game machine 102 and wagering game machine 130 through personal device 120 and personal device 140.

As an example of the operation of the above described system 100, a first user at wagering game machine 102 may wish to share wagering game outcomes with a second user at wagering game machine 130. After communicably coupling the first user's personal device 120 to wagering game machine 102, the first user may issue a request to the second user asking the second user to communicably couple the second user's personal device to wagering game machine 130. The first user may use contact data 126 to determine a network address (e.g., a phone number) for the second user's personal device in order to send the request. After communicably coupling the second user's personal device 140 to wagering game machine 130, a communication path 160 is formed. The communication path 160 may be used to exchange data between the first wagering game machine 102 and the second wagering game machine 130. For example, data representing an outcome of wagering game 104 may be sent through communication interface 110 on wagering game machine 102 to the corresponding communication interface 110 on personal device 120. Communication service 122 may forward the outcome data to network 150 through communication interface 124. Personal device 140 may receive the outcome data through communication interface 124 on personal device 140 and communicate the data to communication service 122 on communication device 140. Communication service 122 may then communicate the outcome data through communication interface 142 to the corresponding communication interface 142 on wagering game machine 130. The outcome data may then be presented to the second user on a display of wagering game machine 130. Other data communication scenarios using communication path 160 are possible and within the scope of the inventive subject matter.

As a second example of the operation of system 100, wagering game machines 102 and 130 may be configured to present a multiplayer game 108. Multiplayer game 108 may be one in which two or more players compete, cooperate, or collaborate with one another during a game. Data for the multiplayer game 108 may be shared between wagering game machines 102 and 130 over the communication path 160 formed by communicably coupling personal devices 120 and 140 to wagering game machines 102 and 130.

Either or both of personal device 120 or personal device 140 may include asset data 128. Asset data 128 may comprise personalized avatars, game symbols, sound clips or other media that may be used to customize or personalize a wagering game 104 or wagering game 134. Such asset data may be shared with users at wagering game machines 102 and 130 using communication path 160.

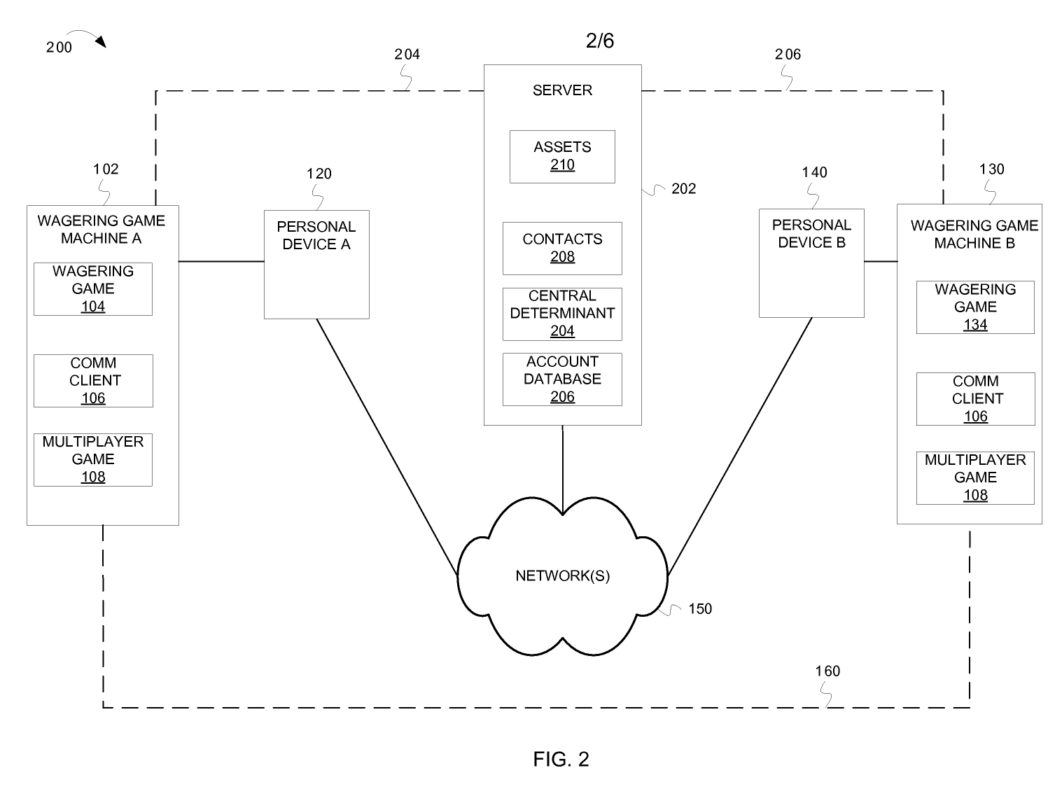

FIG. 2 is a block diagram illustrating components of a system 200 for using personal devices to connect network-limited wagering game machines according to alternative embodiments. Like system 100, system 200 includes wagering game machines 102 and 130 communicably coupled to personal devices 120 and 140 respectively. In addition, system 200 includes server 202. Server 202 includes account database 206 and may also include asset data 210, contact data 208 and central determinant 204. Account database 206 maintains account data for users of system 200. Such account data may include user identifications, passwords, preferences, personalized asset data etc.

Asset data 210 may include image and audio data such as reel symbols, avatars, sound clips, video clips etc. that may be used to personalize wagering games such as wagering game 104 or multiplayer game 108.

Server 202 may optionally include a central determinant 204. Central determinant 204 determines outcomes for games. In some embodiments, central determinant 204 may include a random number generator to produce random numbers that are used to determine game outcomes. In alternative embodiments, central determinant 204 may receive data from multiple wagering game machines that participate in a multiplayer game and uses the data to determine, at least in part, an outcome for the multiplayer game.

Although two wagering game machines, two personal devices and a single server have been shown in FIG. 1 and FIG. 2, those of skill in the art having the benefit of the disclosure will appreciate that a system may have more personal devices, wagering game machines and servers.

Although FIGS. 1 and 2 describe some embodiments, the following sections describe many other features and embodiments.

### Example Operations

This section describes operations associated with some embodiments of the disclosure. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

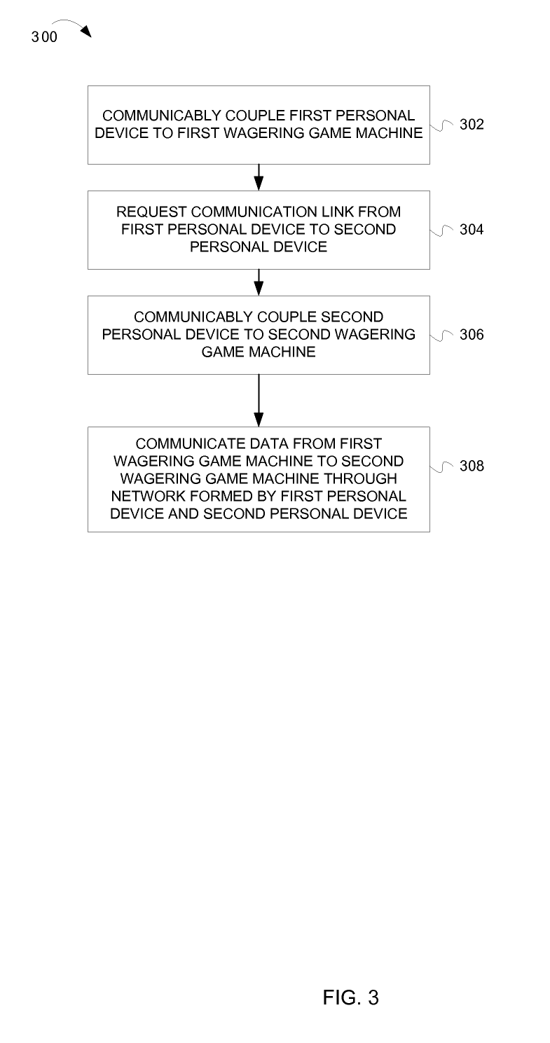

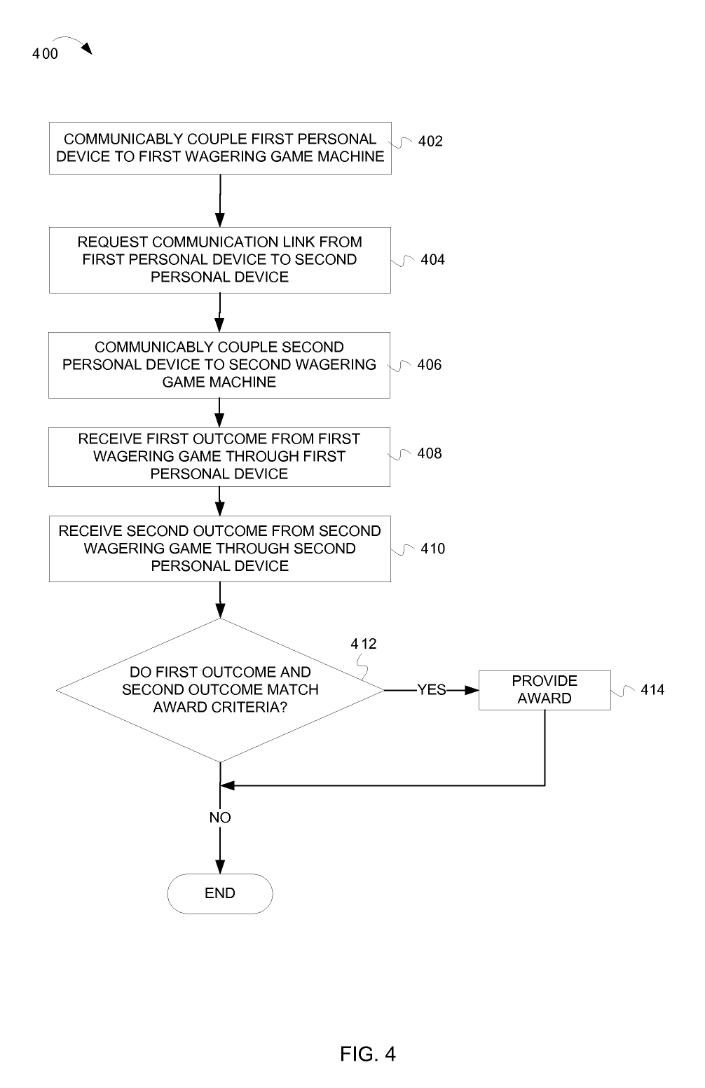

The section will discuss FIGS. 3-4. The discussion of FIG. 3 will describe operations for communicably coupling wagering game machines through personal devices of users of the wagering game machines. The discussion of FIG. 4 will describe operations related to a game playable on wagering game machines that are communicably coupled through personal devices of users of the wagering game machines.

FIG. 3 is a flowchart illustrating a method 300 for communicably coupling wagering game machines using personal devices. Method 300 begins at block 302 with communicably coupling a first personal device to a first wagering game machine. Various methods may be used to initiate the coupling. In some embodiments, a wagering game machine may advertise its availability using a discovery protocol suitable for the type or types of communication interfaces (e.g., communication interfaces 110 or 142) supported by the wagering game machine. Further, the wagering game machine may advertise that it supports various features including the ability to communicate with a second wagering game machine over a network formed by two personal devices. A first user may initiate a communication service on the first user's personal device, which may also participate in the discovery process. Upon discovering an available wagering game machine, a user interface presented on the first user's personal device may prompt the user to communicably couple the user's personal device with the wagering game machine. Alternatively, a first user's personal device may advertise that it is capable of participating in a network formed by two personal devices and a wagering game machine may respond that it is capable of making use of such a network. Further details on a discovery mechanism for communicably coupling a wagering game machine to a personal device may be found in U.S. patent application Ser. No. 13/801,594 entitled “Opt-In Proximity Alert” which is hereby incorporated by reference herein for all purposes.

In alternative embodiments, a NFC protocol may be used where the first user brings the first user's personal device in close proximity to a wagering game machine. The wagering game machine and the first user's personal device detect one another's presence and begin a communication session through communication interfaces on the wagering game machine and the user's personal device.

In further alternative embodiments, a user may scan a code such as a QR (Quick Response) code displayed on the wagering game machine, where the code includes connection data regarding a wagering game machine displaying the QR code. The connection data may specify wireless network configuration information or wireless network identification information that can be used by the first personal device to connect to the first wagering game machine.

In further alternative embodiments, the first user may dock their personal device into a docking port on a wagering game machine.

The first user may also log in to a server (e.g., server 202). In some embodiments, a user may select a server from a user interface. In alternative embodiments, the first user's personal device may use geolocation methods to determine a server. For example, the first user's personal device geolocation may determine that the use is located in a casino. The personal device may automatically log in to the casino operator's server or may suggest the use of the located server. For example, the first user's personal device may automatically select a player tracking server or frequent player server associated with the casino operator for the casino where the first user is located.

At block 304, in some embodiments, a connection request is issued from the first personal device to a second personal device. The connection request may be initiated by the first user through an application (e.g., communication service 122) on the first user's personal device. For example, the first user may be presented with a list of contacts on a user interface presented on the first personal device. The list of contacts may be maintained by social network site such as Facebook or WMS Gaming's Player's Life. In alternative embodiments, a user may be presented with a list of users that have logged into a server that the first user is logged in to.

The first user may select a contact from the list presented on the first user's personal device. The selected contact will be referred to as a second user. A message may then be sent to a personal device associated with the second user. The message may be an SMS (Short Message Service) message inviting the second user to communicably couple their personal device to a wagering game machine. In implementations having a server, the invitation to connect may include a request that the second user log in to the server.

In some implementations, connection requests such as the request issued at block 304 are optional or not used. In such embodiments, connections are made on an ad-hoc basis. Any personal device in communications range may communicably couple available wagering game machines. The users may opt-in to such connections, and may specify conditions under which connections will be made or accepted.

At block 306, the second user communicably couples the second personal device to a second wagering game machine. As with the first user's personal device, the second user's personal device may be communicably coupled to the second wagering game machine using a variety of mechanisms, including discovery protocols, NFC protocols, or physically docking the second personal device to the second wagering game machine.

In addition, a communication session is established between the first personal device and the second personal device. The communication session may be any type of communication session supported by a network connecting the first personal device and the second personal device. For example, the communication network may be a mobile phone network supporting 4G LTE or 3G network communications. Alternatively, the network may be a wireless network.

It should be noted that some or all of the operations described above associated with block 304 and 306 may be optional and not executed in every instance or modified. For instance, a communication session may already be established between a first user's personal device and a second user's personal device. As an example, a first user using the first user's personal device may already be engaged in a chat session using a social networking interface such as WMS Gaming's Player's Life, Facebook etc. with a second user using the second user's personal device. In such cases, the connection request at block 304 may be omitted or may be modified to request that the second user communicably couple the second personal device to a wagering game machine. Further, in such instances block 306 has already been executed and need not be repeated as the first personal device and second personal device are already in communication as a result of the chat session.

At block 308, the first wagering game machine and the second wagering game machine may communicate with one another through the communications path established via the first personal device and the second personal device.

In some embodiments, the data communicated can include outcome data of the first wagering game machine. For example, the first user may desire to share some or all of the outcomes during the first user's wagering game session on the wagering game machine with friends or other contacts. The outcome data may be transmitted from the first wagering game machine to a second wagering game machine in use by the friend or other social contact for display on the second wagering game machine. The outcomes may be filtered. For example, winning outcomes may be communicated with friends or social contacts while non-winning outcomes are not communicated and thus not shared.

Players at wagering game machines communicably coupled through personal devices may share their outcomes. In some embodiments, the presentation of local outcomes and shared outcomes may be coordinated. For example, a first wagering game on the first wagering game machine may not present its outcome until a remote outcome of a second wagering game on the second wagering game machine has been received for presentation on the first wagering game machine.

The data representing the outcomes that are shared between the first wagering game machine and the second wagering game machine may take different forms. In some implementations, screen image data of the outcome may be transmitted from the first wagering game machine to the second wagering game machine and vice versa. In other implementations, data indicating the outcome may be transmitted between wagering game machines, and the outcome recreated on the receiving wagering game machine.

In some embodiments, a player at the first wagering game may place side bets on outcomes generated for wagering games played on the second wagering game machine, referred to as a linked wagering game. Data regarding the outcomes for the linked game is transmitted and received through the communication path established between the first and second wagering game machines using the personal devices communicably coupled to the wagering game machines. Further details on the operation of a linked wagering game are presented in U.S. Pat. No. 8,435,122 entitled “Gaming Device for Wagering on Multiple Game Outcomes” which is hereby incorporated by reference in its entirety for all purposes.

In embodiments that include a server in the communication path (e.g., server 202), wagering game machines may communicate data to the server regarding information about wagering games being played on the wagering game machine. For example, data regarding themes being played or other wagering game options that have been selected may be communicated to the server for later analysis.

FIG. 4 is a flowchart illustrating a method 400 for a multiplayer game on wagering game machines communicably coupled using personal devices. Blocks 402-406 of method 400 correspond to block 302-306 of method 300. That is, block 402-406 of method 400 include operations to communicably couple a first wagering game machine to a first personal device, a second wagering game machine to a second personal device, and establishing a communication path between the first wagering game machine and the second wagering game machine through the first personal device and the second personal device as described above with respect to blocks 302-306.

At block 408, a multiplayer game server receives a first outcome from a first wagering game on a first wagering game machine that is participating in the multiplayer game. For example, in the case of a spinning reel based game, the server may receive an indication of which reel symbols and the positions of the symbols in the outcome. In a card based game, the server may receive an indication of the cards in a hand. In some embodiments, the multiplayer game server may be server 202 illustrated in FIG. 2. In alternative embodiments, one of the wagering game machines participating in the multiplayer game may act as a multiplayer game server. The first outcome is provided to the server though a communications path including the first wagering game machine and the first personal device.

At block 410, the server receives a second outcome from a second wagering game on a second wagering game machine that is participating in the multiplayer game. The outcome is provided to the server though a communications path including the second wagering game machine and the second personal device.

At block 412, the multiplayer game server determines if the first outcome and the second outcome match an award criteria. If the first and second outcomes match the award criteria, then at block 414 an award is provided to the first player and the second player on their respective wagering game machines. In some embodiments, the match criteria may require an exact match between the first and second outcomes. In alternative embodiments, the award criteria may be a match between some or all of the symbols on the paylines in the first and second outcomes, or some or all of the cards in the first and second outcomes. Alternatively, the match criteria may comprise the appearance of bonus symbols on both the first and second outcomes. The level of matching in order to receive an award may vary in different implementations, and the level of award provided at block 414 may depend on the number of matching symbols. The award may comprise credits awarded at the wagering game machines. Alternatively, the award may comprise virtual currency usable at a social network site or other site.

In alternative embodiments, outcomes from two wagering game machines may be compared and an award may be provided to the player with a better outcome. In addition, the occurrence of particular events may trigger a bonus game on either the first or second wagering game machine. In some implementations, the occurrence of a bonus event on either the first wagering game machine or the second wagering game machine may be used to trigger a bonus game on both machines. Data regarding the outcomes on the first wagering game machine and the second wagering game machine may be communicated through the communications path established between the two wagering game machines using personal devices coupled to the wagering game machines. Further details on this type of multiplayer game are provided in U.S. Published Application 2011/0312410 entitled “Wagering Game with Dual-Play Feature” which is hereby incorporated by reference herein for all purposes.

In further alternative embodiments, a multiplayer game may be a competitive game between players at two wagering game machines communicating via a communication path established using personal devices communicably coupled to the two wagering game machines. Various forms of competitive games may be implemented. In some implementations, the competitive game may determine a winner based on the first occurrence of a particular symbol or combination of symbols on one of the wagering game machines. In other implementations, the competitive game may determine a winner based on the most occurrences of a symbol or combination of symbols in a time period. In further implementations, the competitive game may involve determining a winner based on the money won on the wagering game machines participating in the multiplayer game during a particular time period. Data regarding money won, occurrences of symbols etc. can be communicated between the wagering game machines using the communication path established by communicably coupling the wagering game machines using personal devices.

Other types of multiplayer games may be implemented that make use of the communication path established between two wagering game machines using personal devices communicably coupled to the wagering game machines. For example, a community game may make use of the communication path established between two wagering game machines using personal devices communicably coupled to the wagering game machines. A community game is a game in which two or more eligible players jointly participate. A token or symbol representing an individual player within the game is displayed within a screen image that is shared between the first wagering game machine, the second wagering game machine, and other wagering game machines that may participate in the community game. Data regarding the community game (e.g., token positions, symbols, backgrounds, screen images, outcomes etc.) may be transmitted and received over the communication path established between two wagering game machines using personal devices communicably coupled to the wagering game machines. In some implementations, a community game having a side wager feature may be provided. In such implementations, players may make side wagers regarding the positions of tokens on a board for the community game and may make side wagers on outcomes for the community game. Data regarding the side wagers may be transmitted and received over the communication path established between two wagering game machines using personal devices communicably coupled to the wagering game machines. Further details on such a community game are provided in U.S. Pat. No. 7,780,531 entitled “Gaming Machine Having a Community Game with Side Wagering”, which is hereby incorporated by reference herein for all purposes.

The communication path established between wagering game machines using personal devices can be used for other purposes in addition to supporting sharing of game outcomes and multiplayer gaming. For example, in some implementations, game asset data may be loaded from a personal device and shared or traded. For example, customized game symbols such as reel symbols, card symbols etc. may be loaded from a personal device to a first wagering game machine. The customized game symbol may include one or more pictures taken with the phone and uploaded to a wagering game machine or server. The assets may be shared with a second wagering game machine using the communication path established between wagering game machines using personal devices.

A player at a first wagering game machine may share a game with a player at a second wagering game machine. For example, the first player may send a minimal version of a multiplayer game from a first wagering game machine to a friend at a second wagering game machine through a communication path formed by communicably coupling the first wagering game machine and second wagering game machine with personal devices of the first and second player. The second player may then play the multiplayer game with the first player. Alternatively, the first player may send a trial version of a single user game to a second player. The minimal or trial game may be communicated from the first wagering game machine to the second wagering game machine in various ways. In some embodiments, the first wagering game machine sends executable code for the minimal or trial game to the second wagering game machine. The executable code may be sent in the form of an installation package for the wagering game machine.

In alternative embodiments, the first wagering game machine may send a URL (Uniform Resource Locator) or other locator that informs the second wagering game machine where to obtain the minimal or trial version of the multiplayer game.

In further alternative embodiments, the first wagering game machine may send an executable version of the minimal or trial game to the second user's personal device for execution. For example, the first wagering game machine may send an installation package to the second user's personal device, thereby allowing the second user to play the minimal or trial game on the second user's personal device.

The minimal or trial game may be a version that allows wagering for monetary value or it may be a version that is a social game that provides non-monetary winnings such as points, badges, achievement levels etc. The determination to allow wagering for monetary value may be driven by the level of security of the network or network connection between the first user's personal device and the second user's personal device.

The first wagering game machine may also send the second wagering game or second user's personal device a unique identifying code that can be used by the second wagering game machine or second user's personal device to retrieve the minimal or trial game, or to unlock or enable a minimal or trial game that has already been retrieved.

In still further embodiments, a wagering game may be executed on the first wagering game machine and the outcome the wagering game may be communicated to the second user's personal device or second wagering game machine via the communication path established between the first user's personal device and the second user's personal device. In such cases, the first wagering game machine executes two wagering games, a first wagering game for the first player and a second wagering game whose outcomes are communicated to the second player's personal device or wagering game machine via the communication path established between the first user's personal device and the second user's personal device.

The receiving wagering game machine may delete or disable the minimal or trial version of the game when the connection between the wagering game machines is terminated.

### Operating Environment

This section describes an example operating environment and presents structural aspects of some embodiments. This section includes discussion about wagering game machine architectures.

### Wagering Game Machine Architectures

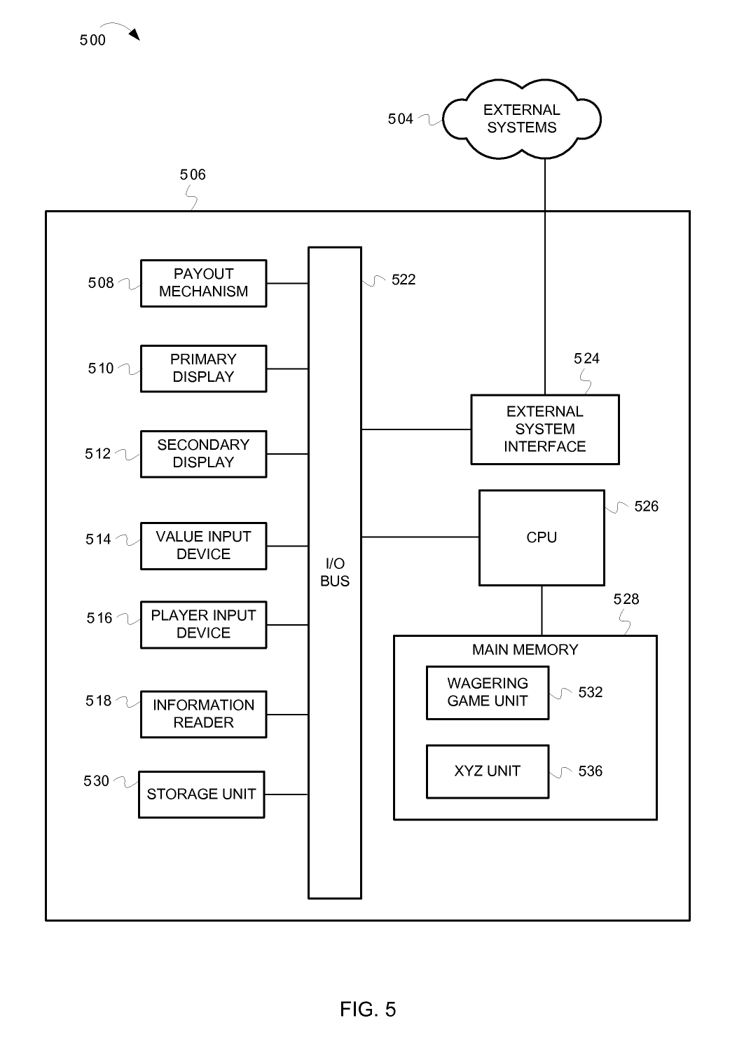

FIG. 5 is a block diagram illustrating a wagering game machine architecture, according to example embodiments of the disclosure. As shown in FIG. 5, the wagering game machine architecture 500 includes a wagering game machine 506, which includes a central processing unit (CPU) 526 connected to main memory 528. The CPU 526 can include any suitable processor, such as an Intel® Pentium processor, Intel® Core 2 Duo processor, AMD Opteron™ processor, or UltraSPARC processor. The main memory 528 includes a wagering game unit 532. In one embodiment, the wagering game unit 532 can present wagering games, such as video poker, video black jack, video slots, video lottery, etc., in whole or part.

The CPU 526 is also connected to an input/output (I/O) bus 522, which can include any suitable bus technologies, such as an AGTL+ frontside bus and a PCI backside bus. The I/O bus 522 is connected to a payout mechanism 508, primary display 510, secondary display 512, value input device 514, player input device 516, information reader 518, and storage unit 530. The player input device 516 can include the value input device 514 to the extent the player input device 516 is used to place wagers. The I/O bus 522 is also connected to an external system interface 524, which is connected to external systems 504 (e.g., wagering game networks).

In one embodiment, the wagering game machine 506 can include additional peripheral devices and/or more than one of each component shown in FIG. 5. For example, in one embodiment, the wagering game machine 506 can include multiple external system interfaces 524 and/or multiple CPUs 526. In one embodiment, any of the components can be integrated or subdivided.

Any component of the architecture 500 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

### Example Wagering Game Machines

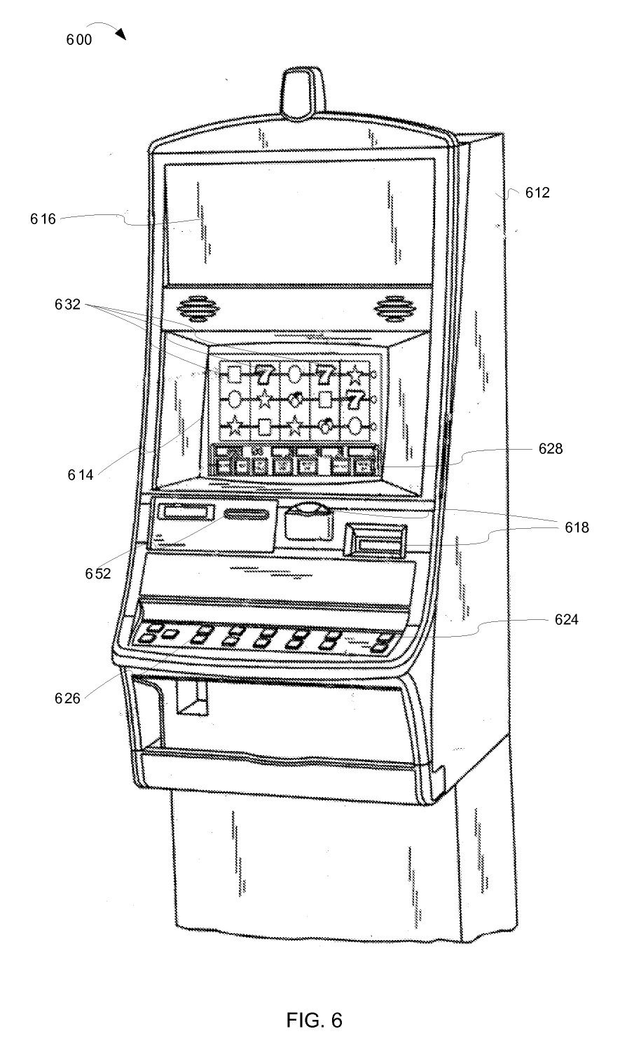

FIG. 6 is a perspective view of a wagering game machine, according to example embodiments of the disclosure. Referring to FIG. 6, a wagering game machine 600 is used in gaming establishments, such as casinos. According to embodiments, the wagering game machine 600 can be any type of wagering game machine and can have varying structures and methods of operation. For example, the wagering game machine 600 can be an electromechanical wagering game machine configured to play mechanical slots, or it can be an electronic wagering game machine configured to play video casino games, such as blackjack, slots, keno, poker, blackjack, roulette, etc.

The wagering game machine 600 comprises a housing 612 and includes input devices, including value input devices 618 and a player input device 624. For output, the wagering game machine 600 includes a primary display 614 for displaying information about a basic wagering game. The primary display 614 can also display information about a bonus wagering game and a progressive wagering game. The wagering game machine 600 also includes a secondary display 616 for displaying wagering game events, wagering game outcomes, and/or signage information. While some components of the wagering game machine 600 are described herein, numerous other elements can exist and can be used in any number or combination to create varying forms of the wagering game machine 600.

The value input devices 618 can take any suitable form and can be located on the front of the housing 612. The value input devices 618 can receive currency and/or credits inserted by a player. The value input devices 618 can include coin acceptors for receiving coin currency and bill acceptors for receiving paper currency. Furthermore, the value input devices 618 can include ticket readers or barcode scanners for reading information stored on vouchers, cards, or other tangible portable storage devices. The vouchers or cards can authorize access to central accounts, which can transfer money to the wagering game machine 600.

The player input device 624 comprises a plurality of push buttons on a button panel 626 for operating the wagering game machine 600. In addition, or alternatively, the player input device 624 can comprise a touch screen 628 mounted over the primary display 614 and/or secondary display 616.

The various components of the wagering game machine 600 can be connected directly to, or contained within, the housing 612. Alternatively, some of the wagering game machine's components can be located outside of the housing 612, while being communicatively coupled with the wagering game machine 600 using any suitable wired or wireless communication technology.

The operation of the basic wagering game can be displayed to the player on the primary display 614. The primary display 614 can also display a bonus game associated with the basic wagering game. The primary display 614 can include a cathode ray tube (CRT), a high resolution liquid crystal display (LCD), a plasma display, light emitting diodes (LEDs), or any other type of display suitable for use in the wagering game machine 600. Alternatively, the primary display 614 can include a number of mechanical reels to display the outcome. In FIG. 6, the wagering game machine 600 is an “upright” version in which the primary display 614 is oriented vertically relative to the player. Alternatively, the wagering game machine can be a “slant-top” version in which the primary display 614 is slanted at about a thirty-degree angle toward the player of the wagering game machine 600. In yet another embodiment, the wagering game machine 600 can exhibit any suitable form factor, such as a free standing model, bartop model, mobile handheld model, or workstation console model.

A player begins playing a basic wagering game by making a wager via the value input device 618. The player can initiate play by using the player input device's buttons or touch screen 628. The basic game can include arranging a plurality of symbols along a payline 632, which indicates one or more outcomes of the basic game. Such outcomes can be randomly selected in response to player input. At least one of the outcomes, which can include any variation or combination of symbols, can trigger a bonus game.

In some embodiments, the wagering game machine 600 can also include an information reader 652, which can include a card reader, ticket reader, bar code scanner, RFID transceiver, or computer readable storage medium interface. In some embodiments, the information reader 652 can be used to award complimentary services, restore game assets, track player habits, etc.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the disclosure, which are defined only by the appended claims. Each of the embodiments described herein are contemplated as falling within the inventive subject matter, which is set forth in the following claims.

What is claimed is:

1. A computer-implemented method comprising:
communicably coupling a first personal computing device to a first wagering game machine; and
communicating data generated by one or more processors of the first wagering game machine to a second wagering game machine through a communications path including the first personal computing device, one or more networks, and a second personal computing device communicably coupled to the second wagering game machine.

2. The computer-implemented method of claim 1, further comprising:
receiving a selection of a contact;
selecting the second personal computing device in accordance with the selection of the contact; and
transmitting a request to connect from the first personal computing device to the second personal computing device.

3. The computer-implemented method of claim 1, wherein communicating data includes communicating outcome data for a wagering game on the first wagering game machine to the second wagering game machine, wherein the second wagering game machine recreates the outcome of the wagering game on the second wagering game machine based on the outcome data.

4. The computer-implemented method of claim 1, further comprising:
generating an outcome for a first wagering game on the first wagering game machine and displaying the outcome on the first wagering game machine; and
generating an outcome for a second wagering game on the first wagering game machine;
wherein communicating data includes communicating the outcome for the second wagering game over the communications path to the second wagering game machine.

5. The computer-implemented method of claim 1, wherein communicating data comprises communicating a URL (Uniform Resource Locator) identifying a location for retrieving a game.

6. One or more machine-readable media having machine executable instructions stored thereon, the machine executable instructions for causing one or more processors to perform operations comprising:
communicably couple a first personal computing device to a first wagering game machine; and
communicating data generated by one or more processors of the first wagering game machine to a second wagering game machine through a communications path including the first personal computing device, one or more networks, and a second personal computing device communicably coupled to the second wagering game machine.

7. The one or more machine-readable media of claim 6, wherein communicably coupling the first personal computing device to the first wagering game machine comprises at least one of establishing a Bluetooth connection, establishing a NFC connection, establishing a WiFi connection, or establishing a USB connection.

8. The one or more machine-readable media of claim 6, wherein the operations further comprise:
receiving a selection of a contact;
selecting the second personal computing device in accordance with the selection of the contact; and
transmitting a request to connect from the first personal computing device to the second personal computing device.

9. The one or more machine-readable media of claim 6, wherein communicating data includes communicating outcome data for a wagering game on the first wagering game machine to the second wagering game machine, wherein the second wagering game machine recreates the outcome of the wagering game on the second wagering game machine based on the outcome data.

10. The one or more machine-readable media of claim 6, wherein the operations further comprise:
generating an outcome for a first wagering game on the first wagering game machine and displaying the outcome on the first wagering game machine; and
generating an outcome for a second wagering game on the first wagering game machine;
wherein communicating data includes communicating the outcome for the second wagering game over the communications path to the second personal computing device.

11. The one or more machine-readable media of claim 6, wherein communicating data includes communicating executable code for a game to the second personal computing device.

12. The one or more machine-readable media of claim 11, wherein the operations further comprise:
determining if the communications path meets a security threshold;
in response to determining that the communications path meets the security threshold, configuring the game to provide monetary value; and
in response to determining that the communications path does not meet the security threshold, configuring the game to provide non-monetary value.

13. The one or more machine-readable media of claim 6, wherein the operations further comprise:
receiving by an intermediate server from the personal computing device communicably coupled to the first wagering game machine a first outcome of a first wagering game on the first wagering game machine;
receiving by the intermediate server from the personal computing device communicably coupled to the second wagering game machine a second outcome of a second wagering game on the second wagering game machine;
determining whether the first outcome and the second outcome meet criteria for an award; and
in response to determining that the first outcome and the second outcome meet the criteria for the award, providing the award.

14. A system comprising:
a first wagering game machine comprising:
one or more processors; and
one or more memory devices to store machine executable instructions, that when executed by the one or more processors, cause the first wagering game machine to:
communicably couple the first wagering game machine to a first personal computing device; and
communicate data generated by the one or more processors to a second wagering game machine through a communications path including the first personal computing device, one or more networks, and a second personal computing device communicably coupled to the second wagering game machine.

15. The system of claim 14, wherein the first personal computing device is communicably coupled to the first wagering game machine by at least one of a Bluetooth connection, an NFC connection, a WiFi connection, or a USB connection.

16. The system of claim 14, wherein the machine executable instructions further include machine executable instructions to cause the one or more processors to:
receive a selection of a contact;
select the second personal computing device in accordance with the selection of the contact; and
transmit a request to connect from the first personal computing device to the second personal computing device.

17. The system of claim 14, wherein the machine executable instructions to cause the one or more processors to communicate data include machine executable instructions to cause the one or more processors to communicate outcome data for a wagering game on the first wagering game machine to the second wagering game machine, wherein the second wagering game machine recreates the outcome of the wagering game on the second wagering game machine.

18. The system of claim 14, further comprising an intermediate server; wherein the one or more networks communicably coupling the first personal computing device to the second personal computing device include the intermediate server, wherein the intermediate server receives login credentials to communicably couple the intermediate server to the first personal computing device.

19. The system of claim 18, wherein the intermediate server is configured to determine an outcome for a multiplayer game presented on the first wagering game machine and the second wagering game machine, the outcome communicated by the intermediate server to the first wagering game machine through the first personal computing device and communicated to the second wagering game machine through the second personal computing device.

20. The system of claim 18, wherein the intermediate server is further configured to:
receive from the first personal computing device communicably coupled to the first wagering game machine a first outcome of a first wagering game on the first wagering game machine;
receive from the second personal computing device communicably coupled to the second wagering game machine a second outcome of a second wagering game on the second wagering game machine;
determine whether the first outcome and the second outcome meet criteria for an award; and
in response to a determination that the first outcome and the second outcome meet the criteria for the award, providing the award.
